(19) United States
(12) Patent Application Publication
(10) Pub. No.: US 2015/0149643 A1
(43) Pub. Date: May 28, 2015

(54) DYNAMIC POLICY BASED DATA SESSION MIGRATION MECHANISM IN A COMMUNICATION NETWORK

(71) Applicant: AT&T Intellectual Property I, LP, Atlanta, GA (US)

(72) Inventors: Qingmin Hu, SAMMAMISH, WA (US); Donald Carl Hjort, ISSAQUAH, WA (US); Sherry L. Mccaughan, QUINTON, VA (US)

(73) Assignee: AT&T Intellectual Property I, LP, Atlanta, GA (US)

(21) Appl. No.: 14/090,396

(22) Filed: Nov. 26, 2013

(51) Int. Cl. H04L 29/06; H04L 29/12

(52) U.S. Cl. CPC H04L 65/1069; H04L 61/20
USPC 709/227

(57) ABSTRACT

Mitigating service interruptions within a mobile core network by dynamically managing communication sessions using a policy based network mechanism is presented herein. A method can include receiving policy information associated with redirection of an active communication session from a first device to a second device; receiving status information representing a characteristic of the active communication session; and in response to determining, based on the status information, that the characteristic satisfies a defined condition of the policy information, redirecting the active communication session from the first device to the second device. In an example, the method can further include redirecting the established communication session from the source device to the destination device in response to determining, based on the data session migration policy, that the established communication session is not associated with a dedicated bearer communication channel.

### BACKGROUND

As mobile broadband services become ubiquitous, people desire 24/7 availability and five nines reliability of Internet protocol (IP) based services including Enhanced 911 (E911) and Voice over IP (VoIP). However, conventional mobile broadband technologies have had some drawbacks with respect to limiting interruptions of such services when performing maintenance within a communication network.

### BRIEF DESCRIPTION OF THE DRAWINGS

Non-limiting embodiments of the subject disclosure are described with reference to the following figures, wherein like reference numerals refer to like parts throughout the various views unless otherwise specified.

FIG. 1 illustrates a block diagram of a core network environment, in accordance with various embodiments;

FIG. 2 illustrates a block diagram of another core network environment, in accordance with various embodiments;

FIG. 3 illustrates a block diagram of a network operation component, in accordance with various embodiments;

FIGS. 4-8 illustrate flowcharts of methods associated with a core network environment, in accordance with various embodiments;

FIG. 9 illustrates a block diagram of a wireless network environment, in accordance various embodiments; and

FIG. 10 is a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

Conventional mobile broadband technologies, e.g., evolved packet system (EPS) based networks, etc. disrupt active, or non-idle, communication sessions when associated network components are serviced. Various embodiments disclosed herein can mitigate service interruptions within a mobile core network by dynamically managing communication sessions using a policy based network mechanism. In this regard, such embodiments can gracefully redirect, migrate, etc. active communication sessions from a first gateway (GW) to a second GW without disruption of associated services, e.g., without dropping voice over long-term evolution (VoLTE) calls.

For example, a method can receive, by a system comprising a processor, e.g., by a network operation server of a core network, policy data from a first device, e.g., a policy server, a policy engine, etc. of the core network. The policy data can represent a data session migration policy, provisioning rule(s), condition(s), etc. for triggering, initiating, etc. a redirection, migration, etc. of an established, active, non-idle, etc. communication session from a source GW device, e.g., from a first communication endpoint of a communication pipe, channel, EPS bearer, etc. to a destination GW device, e.g., to a second communication endpoint of the communication pipe, channel, EPS bearer, etc.—the data session migration policy designating a time of day, traffic load associated with the source GW device, type of the established communication session, etc. for triggering the redirection of the active communication session.

In one embodiment, the method can receive, by the network operation server, information representing a characteristic, a status, etc. associated with the established, active, non-idle, etc. communication session from a second device, e.g., a network information server of the core network. In other embodiment(s), the information can represent a characteristic of the communication pipe, a capacity of the communication pipe, a type of data traffic associated with the communication pipe, a number of established communication sessions associated with the communication pipe, a traffic state of the established communication session, etc. In yet other embodiment(s), the information can represent whether a device, e.g., a GW, a mobility management entity (MME), etc. associated with the communication pipe requires, has been scheduled to have, etc. maintenance; whether there is an established communication path between a mobile device, user equipment (UE), etc. and the GW device, etc.

Furthermore, the method can redirect, by the network operation server, the established communication session from the source GW device to the destination GW device in response to determining that the characteristic of the established communication session satisfies a defined condition of the data session migration policy.

In one embodiment, the method can send, by the network operation server, instruction(s), command(s), etc. to the policy server of the core network to redirect, migrate, etc. the established communication session from the source GW device to the destination GW device. For example, such instruction(s), command(s), etc. can include EPS bearer context procedures with respect to EPS bearer context activation, EPS bearer context deactivation, etc.

In another embodiment, the method can send, by the network operation server, the instruction(s), command(s), etc. to the policy server in response to determining that an IP address assigned to the source GW device has not been assigned to the destination GW device. In this regard, the instructions can initiate assignment of the IP address to the destination GW device, e.g., for effecting redirection of the established communication from the source GW device to the destination GW device.

In another embodiment, the policy data representing the data session migration policy can represent authentication information associated with the mobile device, management information representing a GW management policy, a time based policy, etc. For example, the method can send, by the network operation server, the instruction(s), command(s), etc. to the policy server in response to determining, based on the data session migration policy, that an active communication session between a mobile device and the source GW device is quiescent, e.g., no data packets have been transferred between the mobile device and the source GW device during a designated period.

In another example, the method can send, by the network operation server, the instruction(s), command(s), etc. to the policy server in response to determining, based on the data session migration policy, that the established communication is not associated with a dedicated bearer, e.g., a VoLTE call.

In one embodiment, the method can send, by the network operation server, the instruction(s), command(s), etc. to the policy server in response to determining, based on the data session migration policy, that the established communication is associated with an electronic mail protocol, a simple mail transfer protocol (SMTP), an Internet message access protocol (IMAP), etc.

In another embodiment, the method can send, by the network operation server, the instruction(s), command(s), etc. to the policy server in response to determining, based on the data session migration policy, that the established communication corresponds to a designated time of day, e.g., 2 a.m. local time.

In yet another embodiment, the method can send, by the network operation server, the instruction(s), command(s), etc. to the policy server in response to determining, based on the data session migration policy, that the established communication corresponds to a number of established communications, EPS bearers, etc. associated with the source GW device, e.g., with respect to a determined utilization rate of the source GW device. In one embodiment, the method can send, by the network operation server, the instruction(s), command(s), etc. to the policy server in response to determining, based on the data session migration policy, that the established communication is not associated with a dedicated bearer communication channel.

In one embodiment, a system of a core wireless network can include a network operation server configured to receive, e.g., from a policy server, policy engine, etc. policy information with respect to a redirection, migration, etc. of an active, e.g., non-idle, established, etc. communication session from a first device, e.g., a first GW, etc. to a second device, e.g., a second GW, etc. Further, a network information server of the core wireless network can receive status information representing a characteristic of the active communication session, e.g., a status of a communication pipe, a capacity of the communication pipe, a type of data traffic, EPS bearer, etc. associated with the communication pipe, a number of established communication sessions, EPS bearers, etc. associated with the communication pipe, a traffic state of the established communication session, EPS bearer, etc.

Furthermore, in response to receiving the status information from the network information server, the network operation server can redirect, migrate, etc. the active communication session from the first device to the second device in response to determining, based on the status information, that the characteristic of the active communication satisfies a defined condition represented by the policy information, e.g., that the active communication is quiescent; is not associated with a dedicated bearer, e.g., a VoLTE call; is associated with a designated time of day; corresponds to a defined amount of active communication sessions associated with the first device, e.g., associated with a defined utilization rate, communication bandwidth, etc. of the first device, etc.

In one embodiment, the network operation server can redirect the active communication session from the first device to the second device by sending a command, instruction, etc., for example, including an EPS bearer context communication, to the policy server, policy engine, etc. In another embodiment, the network operation server can redirect the active communication session in response to determining that an IP address associated with the first device has not been associated with the second device. In this regard, the network operation server can assign the IP address to the second device, so that the second device can maintain the active communication, e.g., an active IP connectivity access network (IP-CAN) session, without service interruption, disruption, etc.

Another embodiment can include a computer-readable storage device comprising executable instructions that, in response to execution, cause a system comprising a processor to perform operations, comprising: receiving policy information for migration of a non-idle communication session, e.g., an IP-CAN session, etc. from a first device to a second device; receiving status information representing a characteristic of the non-idle communication; and in response to the status information being determined to satisfy a defined condition of the policy information, migrating the non-idle communication session from the first device to the second device, e.g., without service interruption, disruption, etc.

In one embodiment, the operations can include associating an IP address, which has been assigned to the first device, with the second device in response to determining that the IP address has not been assigned to the second device. Further, the operations can include migrating the non-idle communication session from the first device to the second device in response to determining that the non-idle communication is quiescent, not associated with a dedicated bearer channel, etc.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-ray Disc (BD)); smart card(s); and flash memory device(s) (e.g., card, stick, key drive); and/or a virtual device that emulates a storage device and/or any of the above computer-readable media.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

In accordance with various aspects of the subject specification, artificial intelligence based systems, components, etc. can employ classifiers that are explicitly trained, e.g., via a generic training data, etc. as well as implicitly trained, e.g., via observing characteristics of communication equipment, e.g., a GW, a UE, etc., receiving reports from such communication equipment, receiving operator preferences, receiving historical information, receiving extrinsic information, etc. For example, support vector machines can be configured via a learning or training phase within a classifier constructor and feature selection module. Thus, the classifier(s) can be used by an artificial intelligence system to automatically learn and perform a number of functions, e.g., performed by network information component 120 (see below), including but not limited to determining, deriving, etc. status information representing a characteristic of an active communication session, e.g., an IP-CAN session, an EPS bearer communication, etc. between a source GW and a UE.

Further, the classifier(s) can be used by the artificial intelligence system to automatically determine, based on the status information, that the characteristic satisfies a defined condition with respect to policy data, provisioning rule(s), condition(s), etc. obtained from policy component 140 (see below). Furthermore, the artificial intelligence system can redirect, migrate, etc. the active communication session from the source GW to a destination GW.

For example, the artificial intelligence system, via action component 330 (see below), can automatically determine a target GW based on the policy data, provisioning rule(s), etc, for example, based on a number of sessions to be migrated, based on an estimated capacity of the target GW, other load distribution factors, etc. In another example, the artificial intelligence system, via action component 330, can automatically program, determine, etc. a redirection, migration, etc. schedule of active communication sessions for one or more originating GWs, e.g., based on information representing maintenance to be performed on such GWs, based on status information representing characteristic(s) of the active communication sessions, etc.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Further, as used herein, the terms “user,” “subscriber,” “customer,” “consumer,” “operator,” “network maintenance operator,” “administrator,” and the like refer generally to human entities or automated components supported through artificial intelligence (e.g., a capacity to make inference based on complex mathematical formalisms), which can provide simulated vision, sound recognition and so forth.

As utilized herein, the terms “logic,” “logical,” “logically,” and the like are intended to refer to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Further, the terms “server,” “communication server,” and the like, are utilized interchangeably in the subject application, and refer to a network component or appliance that serves and receives data, control, voice, video, sound, gaming, or substantially any data-stream or signaling-stream to/from other network components, subscriber stations, etc. Data and signaling streams can be packetized or frame-based flows. A network typically includes a plurality of elements that host logic for performing tasks on the network. The logic can be hosted on servers. In modern packet-based wide-area networks, servers may be placed at several logical points on the network. Servers may further be in communication with databases and can enable communication devices to access the contents of a database. Billing servers, application servers, etc. are examples of such servers. A server can include several network elements, including other servers, and can be logically situated anywhere on a service provider's network, such as the back-end of a cellular network. A server can host or can be in communication with a database hosting an account for a user of a mobile device. The “user account” includes several attributes for a particular user, including a unique identifier of the mobile device(s) owned by the user, relationships with other users, application usage, location, personal settings, business rules, bank accounts, and other information. A server may communicate with other servers on different networks to update a user account.

Aspects, features, and/or advantages of the disclosed subject matter can be exploited in substantially any wireless telecommunication or radio technology, e.g., Institute of Electrical and Electronics Engineers (IEEE) 802.XX technology, e.g., Wi-Fi, Bluetooth, etc; worldwide interoperability for microwave access (WiMAX); enhanced general packet radio service (enhanced GPRS); third generation partnership project (3GPP) long term evolution (LTE); third generation partnership project 2 (3GPP2); ultra mobile broadband (UMB); 3GPP universal mobile telecommunication system (UMTS); high speed packet access (HSPA); high speed downlink packet access (HSDPA); high speed uplink packet access (HSUPA); LTE advanced (LTE-A), global system for mobile communication (GSM), near field communication (NFC), Wibree, Wi-Fi Direct, etc.

Further, selections of a radio technology, or radio access technology, can include second generation (2G), third generation (3G), fourth generation (4G), etc. evolution of the radio access technology; however, such selections are not intended as a limitation of the disclosed subject matter and related aspects thereof. Further, aspects, features, and/or advantages of the disclosed subject matter can be exploited in disparate electromagnetic frequency bands. Moreover, one or more embodiments described herein can be executed in one or more network elements, such as a mobile wireless device, e.g., user equipment (UE), and/or within one or more elements of a network infrastructure, e.g., radio network controller, wireless access point (AP), etc.

Moreover, terms like “user equipment,” (UE) “mobile station,” “mobile subscriber station,” “access terminal,” “terminal”, “handset,” “appliance,” “machine,” “wireless communication device,” “cellular phone,” “personal digital assistant,” “smartphone,” “wireless device”, and similar terminology refer to a wireless device, or wireless communication device, which is at least one of (1) utilized by a subscriber of a wireless service, or communication service, to receive and/or convey data associated with storage of objects within a vehicle, voice, video, sound, and/or substantially any data-stream or signaling-stream; or (2) utilized by a subscriber of a voice over IP (VoIP) service that delivers voice communications over IP networks such as the Internet or other packet-switched networks. Further, the foregoing terms are utilized interchangeably in the subject specification and related drawings.

A communication network, e.g., core network environment 100 (see below), for systems, methods, and/or apparatus disclosed herein can include any suitable mobile and/or wireline-based circuit-switched communication network including a global systems for mobile communication (GSM) network, a time division multiple access (TDMA) network, a code division multiple access (CDMA) network, such as IS-95 and subsequent iterations of CDMA technology, an integrated digital enhanced network (iDEN) network and a public switched telephone network (PSTN). Further, examples of the communication network can include any suitable data packet-switched or combination data packet/circuit-switched communication network, wired or wireless IP network such as a VoLTE network, a VoIP network, an IP data network, a universal mobile telecommunication system (UMTS) network, a general packet radio service (GPRS) network, or other communication networks that provide streaming data communication over IP and/or integrated voice and data communication over combination data packet/circuit-switched technologies.

Similarly, one of ordinary skill in the art will appreciate that a wireless system e.g., a wireless communication device, UE 102, UE 104, etc. for systems, methods, and/or apparatus disclosed herein can include a mobile device, a mobile phone, a 4G, etc. cellular communication device, a PSTN phone, a cellular communication device, a cellular phone, a satellite communication device, a satellite phone, a VoIP phone, Wi-Fi phone, a dual-mode cellular/Wi-Fi phone, a combination cellular/VoIP/Wi-Fi/WiMAX phone, a portable computer, or any suitable combination thereof. Specific examples of a wireless system can include, but are not limited to, a cellular device, such as a GSM, TDMA, CDMA, IS-95 and/or iDEN phone, a cellular/Wi-Fi device, such as a dual-mode GSM, TDMA, IS-95 and/or iDEN/VoIP phones, UMTS phones, UMTS VoIP phones, or like devices or combinations thereof.

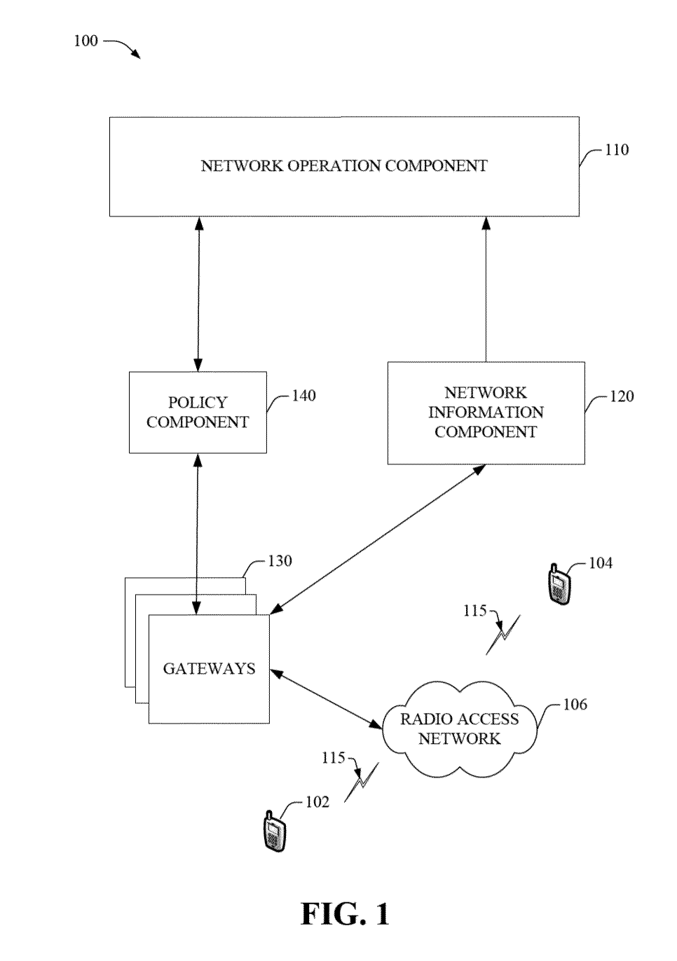

Now referring to FIG. 1, a core network environment 100 for mitigating communication service interruptions is illustrated, in accordance with embodiments. In this regard, in various aspects, network operation component 110 can dynamically manage established, active, non-idle, etc. communication sessions provided to wireless communication devices, e.g., UE 102, UE 104, etc. using a policy based network mechanism.

In one or more embodiments, components of core network environment 100 can provide communication services to UE 102, UE 104, etc. via radio access network 106 utilizing over-the-air wireless link 155. In this regard, radio access network 106 can include one or more: macro, Femto, or pico access points (APs) (not shown); base stations (BS) (not shown); landline networks (e.g., optical landline networks, electrical landline networks) (not shown) communicatively coupled between UE 102, UE 104, etc. and gateways (GWs) 130. Further, over-the-air wireless link 155 can comprise a downlink (DL) and an uplink (UL) (both not shown) that can utilize a predetermined band of radio frequency (RF) spectrum associated with any number of various types of wireless technologies including, but not limited to, cellular, LTE, LTE-A, GSM, 3GPP UMTS, Wi-Fi, WiMax, wireless local area networks (WLAN), Femto, etc.

GWs 130 can include, e.g., a source GW device, a destination GW device, a serving gateway (SGW), a packet data network gateway (PGW), an MME, etc (not shown) that can include any suitable component that can perform centralized routing of a communication, e.g., an IP-CAN communication, an EPS bearer communication, etc. to/from UE 102, UE 104, etc.; that can perform centralized routing of the communication within a mobile, satellite, or similar network (but optionally need not include components that route strictly within a PSTN network); that can perform routing between communication networks of varying architectures, e.g., between cellular, LTE, LTE-A, GSM, 3GPP UMTS, Wi-Fi, WiMax, WLAN, Femto, enterprise VoIP, the Internet, PSTN, or combinations thereof; and the like. Other examples of GWs 130 can include, but are not limited to, a GW mobile switching center (GMSC), a GW general packet radio service (GPRS) support node (GGSN), a session border control (SBC) device, or like devices. Additionally, a data storage component of such system(s), device(s), etc. can include any suitable device, process, and/or combination device that can store digital and/or switched information (e.g., server, data store component, or the like).

Core network environment 100 can include one or more of the Internet (or another communication network (e.g., IP-based network)), or a digital subscriber line (DSL)-type or broadband network facilitated by Ethernet or other technology. In various embodiments, core network environment 100 can include hardware and/or software for allocating resources to UE 102, UE 104, etc., converting or enforcing protocols, establishing and/or providing levels of quality of service (QoS), providing applications or services, translating signals, and/or performing other desired functions to facilitate system interoperability and communication to/from UE 102, UE 104, etc.

In other embodiment(s), core network environment 100 can include data store component(s), a memory configured to store information, and/or computer-readable storage media storing computer-executable instructions enabling various operations performed via network operation component 110 and described herein. In this regard, core network environment 100 can include data store component(s) associated with policy component 140 for storing policy data, provisioning rule(s), condition(s), etc. representing a data session migration policy utilized by network operation component 110 for triggering, initiating, etc. a redirection, migration, etc. of an established, active, non-idle, etc. communication session from a GW of GWs 130 to another GW of GWs 130.

In one embodiment, the data session migration policy can designate a time of day, a traffic load associated with GWs 130, a type of the established communication session, etc. as a condition for triggering redirection of the established communication from the GW to the other GW. In another embodiment, the data session migration policy can represent authentication information associated with UE 102, UE 104, etc, management information representing a GW management policy, a time based policy, etc.

Now referring to FIG. 1, network information component 120 can determine, derive, etc. status information representing a characteristic of an active communication session, e.g., an IP-CAN communication, an EPS bearer communication, etc. provided to UE 102, UE 104, etc. via a source GW of GWs 130. In one or more embodiments, the status information can represent a status of a communication pipe, a capacity of the communication pipe, a type of data traffic, EPS bearer, etc. associated with the communication pipe, a number of active communication sessions, EPS bearers, etc. associated with the communication pipe and/or the source GW, a traffic state of the active communication session, EPS bearer, etc.

In response to receiving status information from network information component 120, and in response to receiving policy data, provisioning rule(s), conditions(s), etc. from policy component 140, network operation component 110 can redirect, migrate, etc. the active communication session from the source GW to a destination GW of GWs 130 in response to determining, based on the status information, that the characteristic of the active communication satisfies a defined condition represented by the policy data, the provisioning rule(s), condition(s), etc., e.g., that the active communication is quiescent, that the active communication is not associated with a dedicated bearer, that the active communication is associated with a designated time of day, that the active communication corresponds to a defined amount of active communication sessions associated with the source GW, e.g., with respect to a defined utilization rate, communication bandwidth, etc. of the source GW, etc.

In one embodiment, network operation component 110 can send instruction(s), command(s), etc. to policy component 140 to redirect, migrate, etc. the active communication session from the source GW to the destination GW. For example, such instruction(s), command(s), etc. can include EPS bearer context communication(s), procedure(s), etc. with respect to an EPS bearer context activation, an EPS bearer context deactivation, etc. In another embodiment, network operation component 110 can determine that an IP address assigned to the source GW has not been assigned to the destination GW. Further, network operation component 110 can send instruction(s), command(s), etc. to policy component 140 to initiate assignment of the IP address to the destination GW. In this regard, network operation component 110 can facilitate maintaining the active communication utilizing the destination GW without service interruption, disruption, etc.

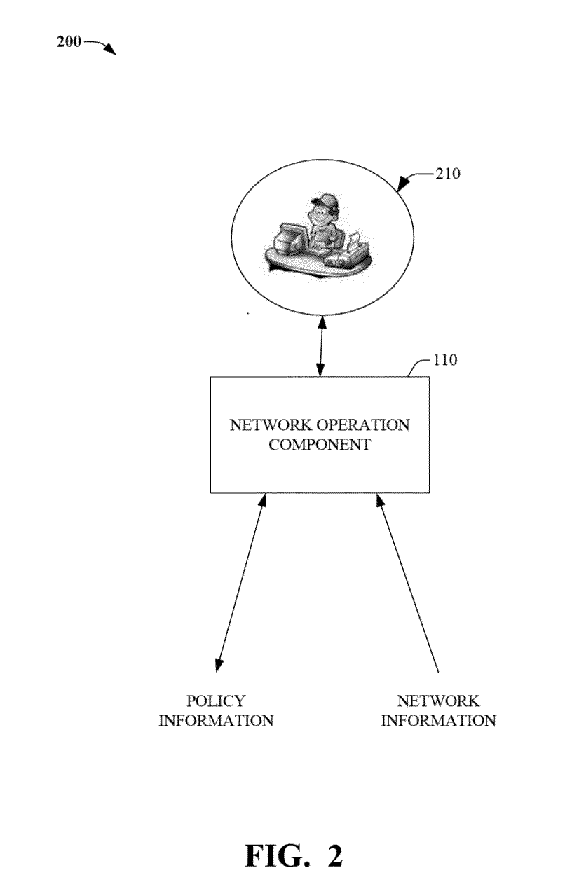

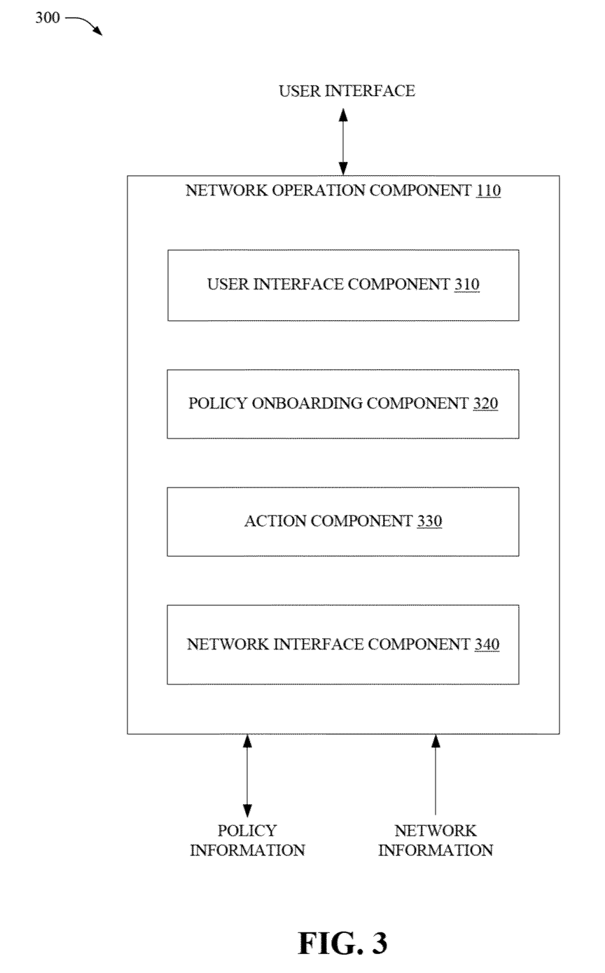

Referring now to FIG. 2 and FIG. 3, a block diagram of another core network environment (200), and a block diagram (300) of network operation component 110 are illustrated, respectively, in accordance with various embodiments. Network operation component 110 can include user interface component 310, policy onboarding component 320, action component 330, and network interface component 340. As illustrated by FIG. 2, user interface component 310 can include a web-based, graphical user interface (GUI) 210 that can act as a “control interface” communicatively coupled, via network operation component 110, to component(s), device(s), etc. of core network environment 100, 200, etc. In this regard, user interface component 310 can be configured to display, via a monitor, display device, etc. (not shown) status information, network information, etc. reported by network information component 120. Such information can enable a network maintenance operator, administrator, etc. of network operation component 110, core network environment 200, etc. to monitor active GWs of GWs 130, view statistics and/or information representing operation of GWs 130, and/or devices of core network environment 200, etc. For example, user interface component 310 can be configured to display a representation of active GWs of GWs 130; display defined statistics of GWs 130; display operational state(s) of GWs 130, e.g., whether a GW is operational, functioning according to defined operational standards, etc.; display information representing a capacity of a GW of GWs 130; display information representing a number of concurrent communication sessions, data sessions, etc. associated with the GW; etc.

In one embodiment, an access control component (not shown) of network operation component 110 can authorize the network maintenance operator, e.g., via a secured, password protected, etc. login procedure, to access status information associated with component(s), communication(s), etc. of core network environment 200, and/or to control operation(s), communication(s), etc. of such component(s). In this regard, user interface component 310 can be configured to receive, via input device(s), e.g., a keyboard, a microphone, etc. (not shown) input from the network maintenance operator for configuring, initiating, modifying, etc. various components and/or policies associated with core network environment 200.

In an embodiment, policy onboarding component 320 can be configured to create, define, modify, etc. policy data, provisioning rule(s), etc. based on input received from the network maintenance operator via user interface component 310. For example, the input can represent authentication information associated with a mobile device, management information representing a management policy for GWs 130, a data session migration policy, a time based policy, etc. In one example, the data session migration policy can designate a time of day, a traffic load associated with GWs 130, a type of the established communication session, etc. as a condition for triggering redirection, migration, etc. of the active communication from the source GW to the destination GW.

In one embodiment, action component 330 can be configured to modify the configuration of, perform actions on, etc. GW(s), communication(s), component(s), etc. of core network environment 200 based on input received from the network maintenance operator via user interface component 310. For example, user interface component 310 can display a representation of originating GW(s), source GW(s), etc. and target GW(s), destination GW(s), etc. of GWs 130. Further, in response to detecting a selection of an originating GW and a target GW, interface component 310 can display information representing a target time (Ts) to start, begin, etc. a redirection, migration, etc. of an established, active, etc. communication from the originating GW to the target GW, e.g., in anticipation of maintenance to be performed on the originating GW.

In another embodiment, action component 330 can be configured to automatically determine the target GW based on the policy data, provisioning rule(s), etc. For example, action component 330 can determine the target GW based on a number of sessions to be migrated, based on an estimated capacity of the target GW, other load distribution factors, etc.

In yet another embodiment, action component 330 can be configured to automatically program, determine, etc. a redirection, migration, etc. schedule of active communication sessions for one or more originating GWs of GWs 130, e.g., based on information representing maintenance to be performed on such GWs, based on status information representing characteristic(s) of the active communication sessions, etc.

In one embodiment, in response to determining that the target time, e.g., corresponding to a time of day and date, etc. has been reached, action component 330 can send, e.g., via policy component 140, an instruction, command, etc. to the originating GW to reject, or “dry out”, new communication requests associated with the originating GW during a “drying out” period, and redirect new session requests to the target GW. Further, action component 330 can determine, e.g., via network information component 120, that there are active communication sessions on the originating GW with a dedicated bearer, e.g., a VoLTE call, and select other, e.g., non-dedicated bearer, active communication sessions associated with the originating GW to redirect, migrate, etc. from the originating GW to the target GW.

In another embodiment, to facilitate redirection, migration, etc. of an active, non-dedicated bearer communication session between a UE and the originating GW to the target GW, action component 330 can utilize a “make-before-break” technique by establishing, setting up, etc. a new non-dedicated bearer communication session, e.g., an IP-CAN session, between the UE and the target GW, e.g., based on IP-CAN sessions associated with the target GW that have been determined to be inactive, e.g., in response to such sessions being determined to have inactive timers. For example, action component 310 can dynamically establish the new non-dedicated bearer communication session on the target GW by assigning an IP address of the originating GW to the target GW—the target GW and the originating GW transferring duplicate non-dedicated bearer communication sessions associated with the UE at the same time.

In yet another embodiment, in response to establishing the new non-dedicated bearer communication session between the UE and the target GW, action component 330 can send, via policy component 140, instruction(s), command(s), etc. to terminate, tear down, etc. an old non-dedicated bearer communication session between the UE and the originating GW, e.g., by sending a command, instruction, etc. corresponding to an EPS bearer context deactivation procedure to an MME, e.g., triggering the MME to issue a non-access stratum (NAS) deactivate EPS bearer context request message to the UE.

Further, in response to determining that an established communication session has been redirected from a first GW to a second GW, action component 330 can send, via user interface component 320, a message to the network maintenance operator, e.g., via GUI 210, that such session has been redirected.

In another embodiment, action component 330 can migrate, based on input received from the network maintenance operator via GUI 210, the established communication session from the second GW back to the first GW in response to determining that a communication state of the UE, an operator policy, etc. satisfies a defined condition represented by the policy data. Further, action component 330 can automatically calculate a percentage of communication sessions that have been migrated back to the first GW, and inform the network maintenance operator of the percentage via GUI 210.

In one embodiment, network interface component 340 can facilitate interoperability and communication between network operation component 110 and various systems, devices, components, etc., e.g., network information component 120, policy component 140, GWs 130, an MME, etc. of core network environments 100, 200, etc. utilizing wired and/or wireless interfaces.

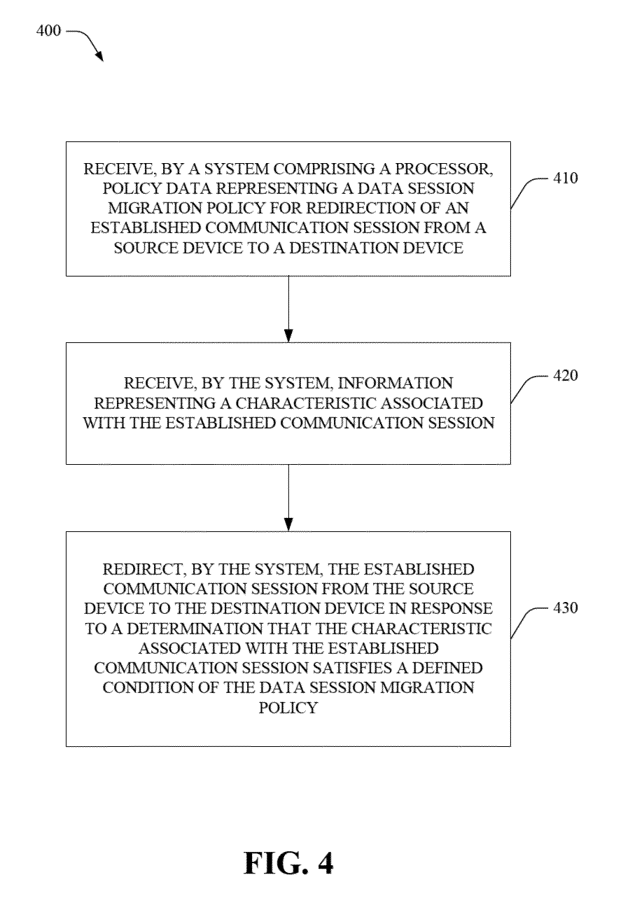

FIGS. 4-8 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIGS. 4-8, processes 400 to 800 performed by component(s) described herein, e.g., network operation component 110, are illustrated, in accordance with various embodiments. At 410, policy data representing a data session migration policy for redirection of an established communication session from a source device, e.g., an originating GW, to a destination device, e.g., a target GE, can be received, e.g., by a system comprising a processor. At 420, information representing a characteristic associated with the established communication session can be received by the system. At 430, the established communication session can be redirected, by the system, from the source device to the destination device in response to a determination that the characteristic satisfies a defined condition of the data session migration policy.

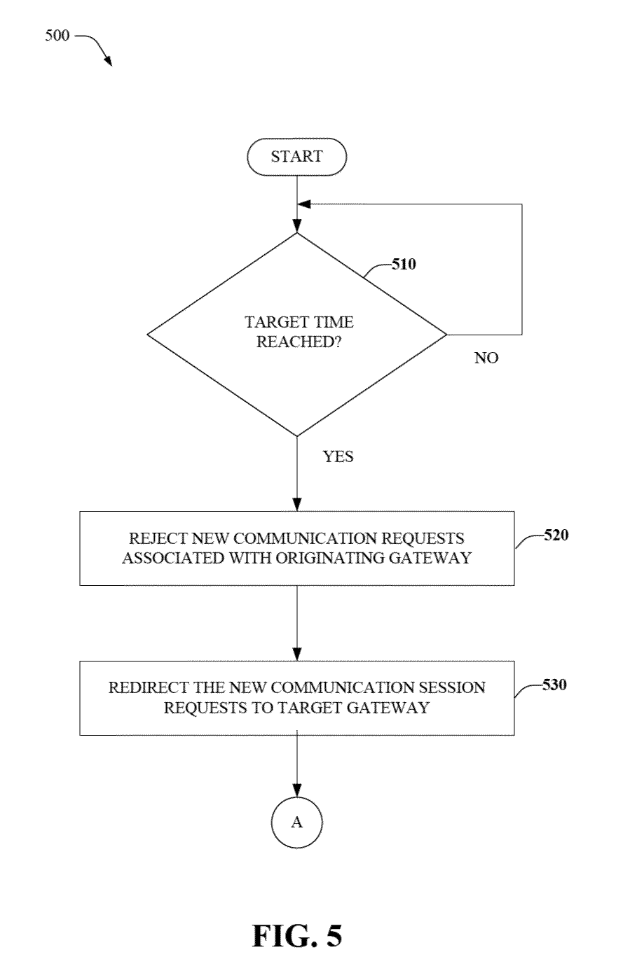

Referring to embodiment(s) illustrated by FIG. 5, it can be determined at 510 whether a target time (Ts) to start, begin, etc. a redirection, migration, etc. of established, active, etc. communication session(s) from the originating GW to the target GW, e.g., with respect to scheduled maintenance of component(s) of the originating GW, has been reached. If it is determined that Ts has been reached, flow continues to 520, at which new communication session requests associated with the originating GW can be rejected, e.g., during a “dry out” period. Further, at 530, the new communication session requests can be redirected to the target GW.

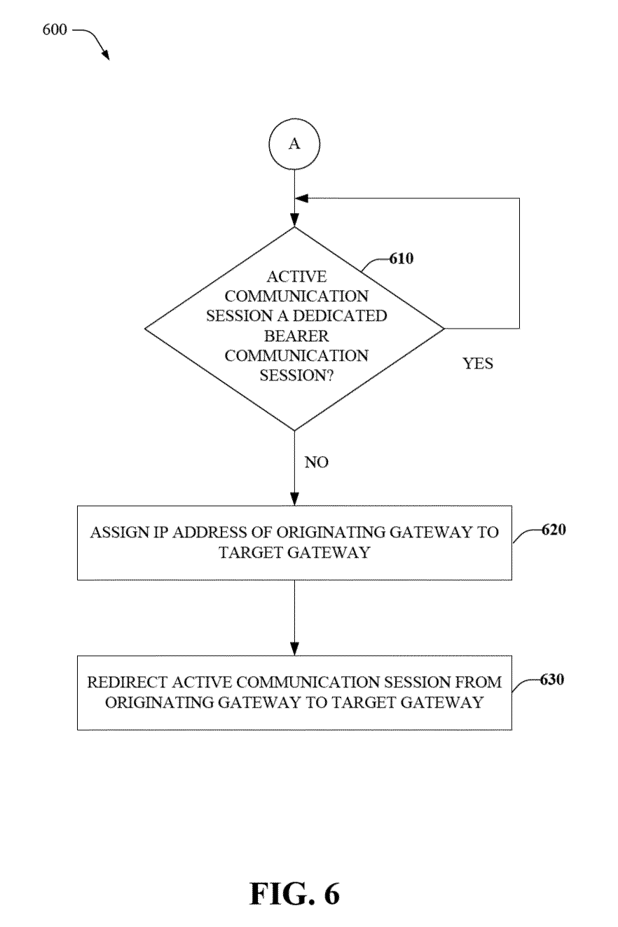

Referring now to FIG. 6, at 610, it can be determined whether an active communication session corresponding to an originating GW is a dedicated bearer communication session, e.g., a VoLTE call. If it is determined that the active communication session is a dedicated bearer communication session, flow returns to 610, e.g., method 600 waits for the VoLTE call to finish; otherwise, flow continues to 620, at which an IP address of the originating GW can be assigned to a target GW. At 630, the active communication session can be redirected from the originating GW to the target GW.

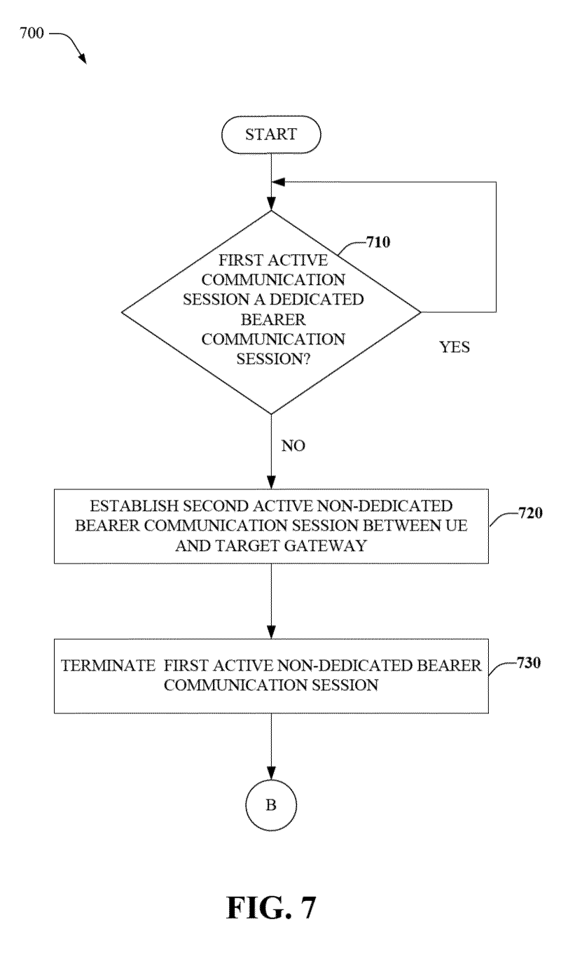

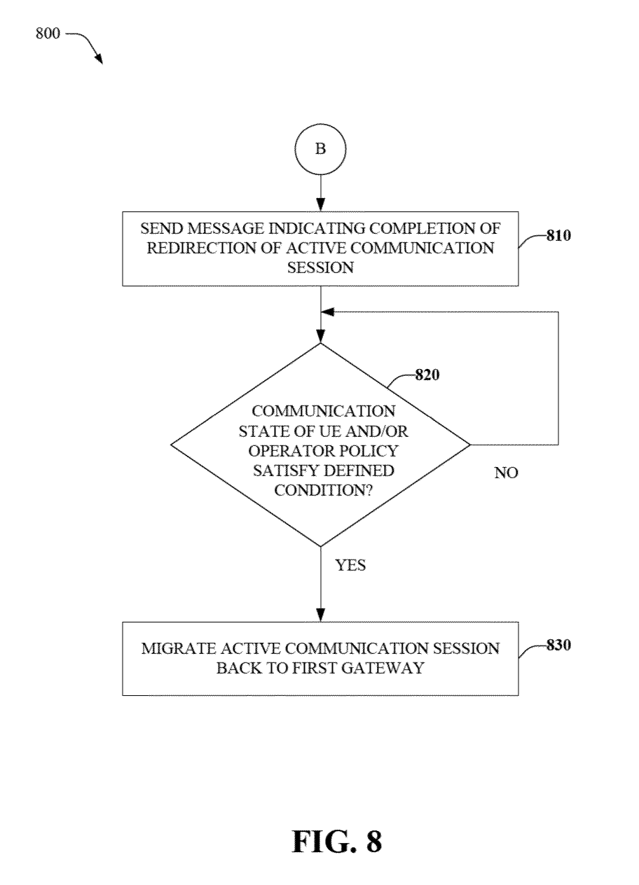

Now referring to FIGS. 7 and 8, at 710, it can be determined whether a first active communication session associated with a UE and a first GW is a dedicated bearer communication session. If it is determined that the first active communication is a dedicated bearer communication session, flow returns to 710; otherwise, a second active communication session, which is a non-dedicated bearer communication session, can be established between the UE and a second GW at 720. At 730, the first active communication session, e.g., non-dedicated bearer communication session, can be terminated.

At 810, a message indicating completion of the redirection of the active communication session can be sent, e.g., to an operator via GUI 210. At 820 it can be determined whether a communication state of the UE, and/or an operator policy, satisfy a defined condition with respect to migrating the active communication session back to the first GW. If it is determined that the communication state of the UE, and/or the operator policy, satisfy the defined condition, flow continues to 830, at which the active communication session can be migrated back to the first GW; otherwise flow returns to 820.

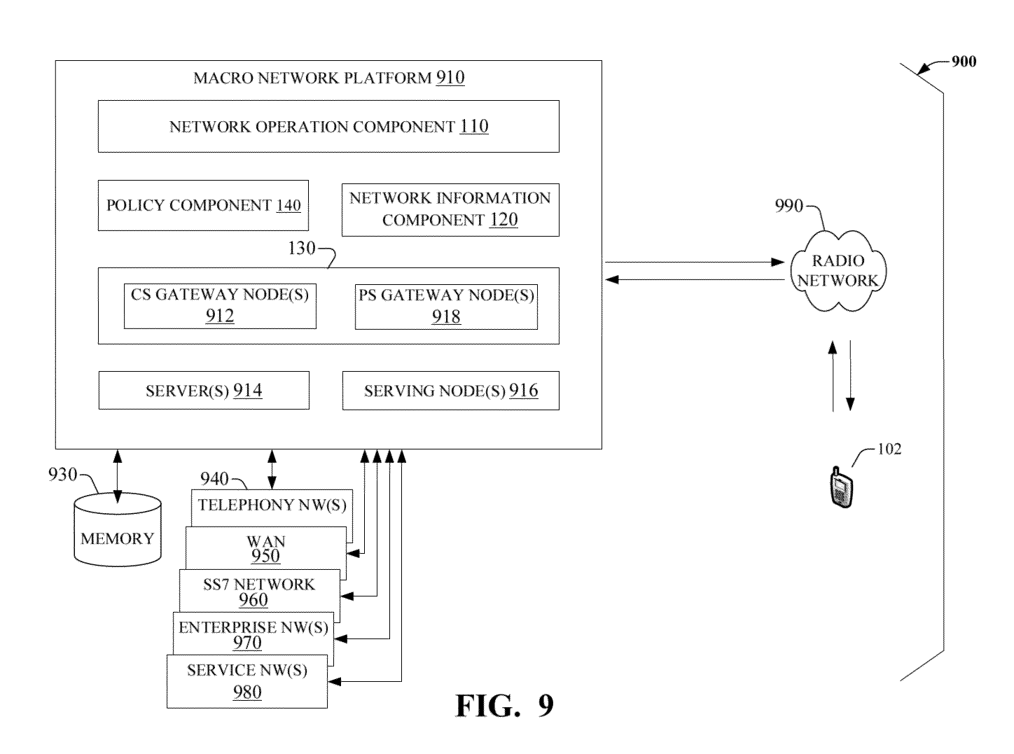

With respect to FIG. 9, a wireless communication environment 900 including macro network platform 910 is illustrated, in accordance with an embodiment. Macro network platform 910 serves or facilitates communication with UE 102. It should be appreciated that in cellular wireless technologies, e.g., 3GPP UMTS, HSPA, 3GPP LTE, 3GPP2 UMB, LTE-A, etc. that can be associated with radio network 990, e.g., RAN 106, etc. macro network platform 910 can be embodied in a core network. It is noted that radio network 990 can include base station(s), base transceiver station(s), access point(s), etc. and associated electronic circuitry and deployment site(s), in addition to a wireless radio link operated in accordance with the base station(s), etc. Accordingly, radio network 990 can comprise various coverage cells, or wireless coverage areas.

Generally, macro network platform 910 includes components, e.g., nodes, GWs, interfaces, servers, platforms, etc. that facilitate both packet-switched (PS), e.g., IP, frame relay, asynchronous transfer mode (ATM), and circuit-switched (CS) traffic, e.g., voice and data, and control generation for networked wireless communication. In various embodiments, macro network platform 910 includes GWs 130, which can include CS GW node(s) 912 that can interface CS traffic received from legacy networks like telephony network(s) 940, e.g., public switched telephone network (PSTN), public land mobile network (PLMN), Signalling System No. 7 (SS7) network 960, etc. Circuit switched GW 912 can authorize and authenticate traffic, e.g., voice, arising from such networks. Additionally, CS GW 912 can access mobility or roaming data generated through SS7 network 960; for instance, mobility data stored in a visitor location register (VLR), which can reside in memory 930. Moreover, CS GW node(s) 912 interfaces CS-based traffic and signaling with PS GW node(s) 918. As an example, in a 3GPP UMTS network, PS GW node(s) 918 can be embodied in GW GPRS support node(s) (GGSN).

As illustrated by FIG. 9, GWs 130 can include PS GW node(s) 918, which can receive and process CS-switched traffic and signaling via CS GW node(s) 912. Further PS GW node(s) 918 can authorize and authenticate PS-based data sessions with served, e.g., via radio network 990, wireless devices, e.g., UE 102. Data sessions can include traffic exchange with networks external to the macro network platform 910, like wide area network(s) (WANs) 950; enterprise networks (NWs) 970, e.g., E911, service NW(s) 980, e.g., an IP multimedia subsystem (IMS), etc. It should be appreciated that local area network(s) (LANs), which may be a part of enterprise NW(s) 970, can also be interfaced with macro network platform 910 through PS GW node(s) 918. PS GW node(s) 918 can generate packet data contexts when a data session is established, e.g., associated with an EPS bearer context activation. To that end, in an aspect, PS GW node(s) 918 can include a tunnel interface, e.g., tunnel termination GW (TTG) in 3GPP UMTS network(s) (not shown), which can facilitate packetized communication with disparate wireless network(s), such as Wi-Fi networks. It should be further appreciated that the packetized communication can include multiple flows that can be generated through server(s) 914. It is to be noted that in 3GPP UMTS network(s), PS GW node(s) 918 (e.g., GGSN) and tunnel interface (e.g., TTG) comprise a packet data GW (PDG).

Macro network platform 910 also includes serving node(s) 916 that can convey the various packetized flows of information, or data streams, received through PS GW node(s) 918. As an example, in a 3GPP UMTS network, serving node(s) can be embodied in serving GPRS support node(s) (SGSN).

As indicated above, server(s) 914 in macro network platform 910 can execute numerous applications, e.g., messaging, location services, wireless device management, etc. that can generate multiple disparate packetized data streams or flows; and can manage such flows, e.g., schedule, queue, format. Such application(s), for example can include add-on features to standard services provided by macro network platform 910. Data streams can be conveyed to PS GW node(s) 918 for authorization/authentication and initiation of a data session, and to serving node(s) 916 for communication thereafter. Server(s) 914 can also effect security, e.g., implement one or more firewalls, of macro network platform 910 to ensure network's operation and data integrity in addition to authorization and authentication procedures that CS GW node(s) 912 and PS GW node(s) 918 can enact. Moreover, server(s) 914 can provision services from external network(s), e.g., WAN 950, or global positioning system (GPS) network(s), which can be a part of enterprise NW(s) 980. It is to be noted that server(s) 914 can include one or more processors configured to confer at least in part the functionality of macro network platform 910. To that end, the one or more processors can execute code instructions stored in memory 930, for example.

In example wireless communication environment 900, memory 930 stores information related to operation of macro network platform 910. The information can include business data associated with subscribers; market plans and strategies, e.g., promotional campaigns, business partnerships, mobile devices served through macro network platform, etc.; service and privacy policies; end-user service logs for law enforcement; term(s) and/or condition(s) associated with wireless service(s) provided via radio network 990; and so forth. Memory 930 can also store information from at least one of telephony network(s) 940, WAN 950, SS7 network 960, enterprise NW(s) 970, or service NW(s) 980.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in non-volatile memory 1022 (see below), disk storage 1024 (see below), and/or memory storage 1046 (see below). Further, nonvolatile memory can be included in read only memory (ROM), programmable ROM (PROM), electrically programmable ROM (EPROM), electrically erasable ROM (EEPROM), or flash memory. Volatile memory 1020 can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

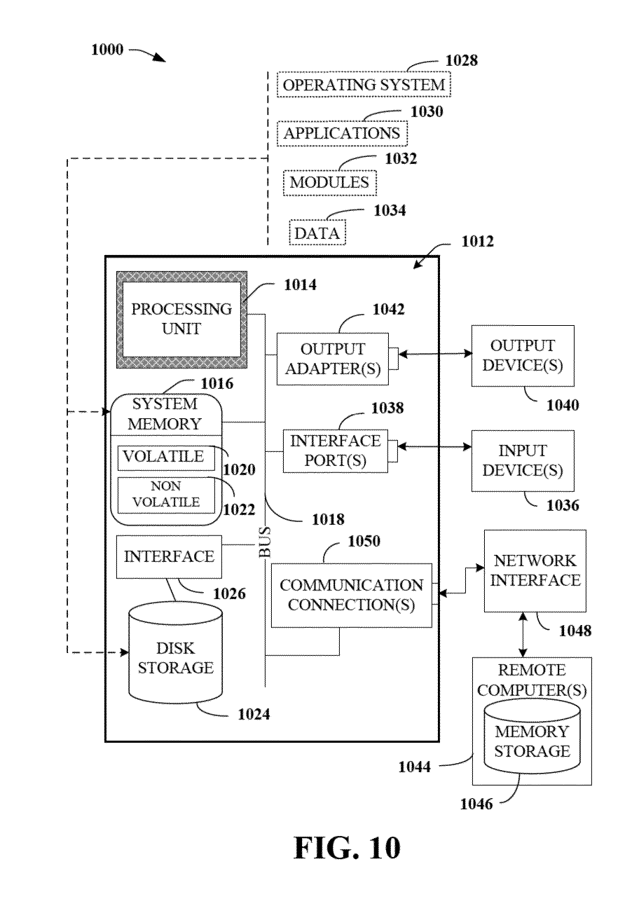

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules include routines, programs, components, data structures, etc. that perform particular tasks and/or implement particular abstract data types.

Moreover, those skilled in the art will appreciate that the inventive systems can be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 10, a block diagram of a computing system 1000 operable to execute the disclosed systems and methods is illustrated, in accordance with an embodiment. Computer 1012 includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1016 includes volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can include ROM, PROM, EPROM, EEPROM, or flash memory. Volatile memory 1020 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

It is to be appreciated that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be appreciated that the disclosed subject matter can be implemented with various operating systems or combinations of operating systems.

A user can enter commands or information into computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1014 through system bus 1018 via interface port(s) 1038. Interface port(s) 1038 include, for example, a serial port, a parallel port, a game port, a universal serial bus (USB), a wireless based port, e.g., Wi-Fi, Bluetooth, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040, like display devices, light projection devices, monitors, speakers, and printers, among other output devices 1040, which use special adapters. Output adapters 1042 include, by way of illustration and not limitation, video and sound devices, cards, etc. that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically and/or wirelessly connected via communication connection 1050. Network interface 1048 encompasses wire and/or wireless communication networks such as local-area networks (LAN) and wide-area networks (WAN). LAN technologies include fiber distributed data interface (FDDI), copper distributed data interface (CDDI), Ethernet, token ring and the like. WAN technologies include, but are not limited to, point-to-point links, circuit switching networks like integrated services digital networks (ISDN) and variations thereon, packet switching networks, and digital subscriber lines (DSL).

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and DSL modems, wireless modems, ISDN adapters, and Ethernet cards.

The computer 1012 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1012 can connect to other devices/networks by way of antenna, port, network interface adaptor, wireless access point, modem, and/or the like.

The computer 1012 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This includes at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11(a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A method, comprising:
receiving, by a system comprising a processor, policy data representing a data session migration policy for redirection of an established communication session from a source device to a destination device;
receiving, by the system, information representing a characteristic associated with the established communication session; and
in response to determining, based on the information, that the established communication session is not associated with a dedicated bearer communication channel, redirecting, by the system based on the policy data, the established communication session from the source device to the destination device.

2. The method of claim 1, wherein the redirecting comprises:
sending an instruction directed to a policy device relating to activation of a bearer context.

3. The method of claim 1, wherein the redirecting comprises:
in response to determining that an internet protocol address assigned to the source device has not been assigned to the destination device, assigning the internet protocol address to the destination device.

4. The method of claim 3, wherein the redirecting comprises:
in response to determining, based on the data session migration policy, that the established communication session is quiescent, redirecting the established communication session from the source device to the destination device.

5. The method of claim 1, wherein the redirecting comprises:
establishing a non-dedicated bearer communication session between the destination device and a remote device corresponding to the established communication session.

6. The method of claim 1, wherein the redirecting comprises:
in response to determining, based on the data session migration policy, that the established communication session corresponds to a designated period, redirecting the established communication session from the source device to the destination device.

7. The method of claim 6, further comprising:
rejecting, by the system, a data session request corresponding to the source device.

8. The method of claim 1, wherein the redirecting comprises:
in response to determining, based on the data session migration policy, that the established communication session corresponds to a defined condition with respect to an amount of established communications associated with the source device, redirecting the established communication session from the source device to the destination device.

9. A system, comprising:
a processor; and
a memory that stores executable instructions that, when executed by the processor, facilitate performance of operations, comprising:
receiving policy information associated with redirection of an active communication session from a first device to a second device;
receiving status information representing a characteristic of the active communication session; and
in response to determining, based on the status information, that the active communication session is not associated with a dedicated bearer, redirecting, based on the policy information, the active communication session from the first device to the second device.

10. The system of claim 9, wherein the redirecting of the active communication session comprises sending an instruction to a policy device, wherein the instruction is associated with activation of a bearer context.

11. The system of claim 9, wherein the redirecting of the active communication session comprises:
in response to determining that an internet protocol address associated with the first device has not been associated with the second device, associating the internet protocol address with the second device.

12. The system of claim 9, wherein the redirecting of the active communication session comprises:
in response to determining that the active communication session is quiescent, redirecting the active communication session from the first device to the second device.

13. The system of claim 9, wherein the redirecting of the active communication session comprises:
establishing a non-dedicated bearer communication session between the second device and a remote device corresponding to the active communication session.

14. The system of claim 9, wherein the redirecting of the active communication session comprises:
in response to determining that the active communication session is associated with a designated time of day, redirecting the active communication session from the first device to the second device.

15. The system of claim 14, wherein the operations further comprise:
rejecting a communication session request corresponding to the first device.

16. The system of claim 9, wherein the redirecting of the active communication session comprises:
in response to determining that the active communication session corresponds to a an amount of active communication sessions associated with the first device, redirecting the active communication session from the first device to the second device.

17. A computer-readable storage device comprising executable instructions that, in response to execution, cause a system comprising a processor to perform operations, comprising:
receiving policy information for migration of a non-idle communication session from a first device to a second device;
receiving status information representing a characteristic of the non-idle communication session; and
in response to determining, based on the status information, that the non-idle communication session is not associated with a dedicated bearer, migrating the non-idle communication session from the first device to the second device according to the policy information.

18. The computer-readable storage device of claim 17, wherein the migrating of the non-idle communication session comprises:
in response to determining that an internet protocol address associated with the first device has not been associated with the second device, associating the internet protocol address with the second device.

19. The computer-readable storage device of claim 17, wherein the migrating of the non-idle communication session comprises:
in response to determining that the non-idle communication session is quiescent, migrating the non-idle communication session from the first device to the second device.

20. The computer-readable storage device of claim 17, wherein the migrating of the non-idle communication session comprises:
establishing a non-dedicated bearer communication between the second device and a remote device corresponding to the non-idle communication session.
